(19) United States
(12) Patent Application Publication
(10) Pub. No.: US 2014/0157036 A1
(43) Pub. Date: Jun. 5, 2014

(54) ADVANCED AND AUTOMATIC ANALYSIS OF RECURRENT TEST FAILURES

(71) Applicant: Microsoft Corporation, Redmond, WA (US)

(72) Inventors: Thomas Walton, Seattle, WA (US); Herman Widjaja, Sammamish, WA (US); Anish Swaminathan, Sea Tac, WA (US); Andrew Precious, Duvall, WA (US); Edwin Bruce Shankle, III, Cary, NC (US); Andrew Campbell, Kirkland, WA (US); Sean Edmison, Redmond, WA (US); Jacob Beaudoin, Raleigh, NC (US)

(73) Assignee: Microsoft Corporation, Redmond, WA (US)

(21) Appl. No.: 13/689,754

(22) Filed: Nov. 30, 2012

(51) Int. Cl. G06F 11/07; G06F 11/00

(52) U.S. Cl. CPC G06F 11/079; G06F 11/006; G06F 11/0793
USPC 714/2; 714/48; 714/57; 714/39

(57) ABSTRACT

In one embodiment, a test case run analyzer may filter out failure events with known causes from a test report. The test case run analyzer may receive a test report of a test case run of an application process. The test case run analyzer may automatically identify a failure event in the test case run. The test case run analyzer may automatically compare the failure event to a failure pattern set. The test case run analyzer may filter the test report based on the failure pattern set.

### BACKGROUND

When a known issue causes recurring failures across multiple test passes, each failure is analyzed to determine a resolution. A human tester may manually evaluate the failures by examining the results of the test to determine whether the failure is the result of a known incongruity, or “bug”. The failure may then be associated with the appropriate bug report. Manually examining and evaluating each failure is a time intensive process. The test may see a failure repeatedly, due to an unfixed bug, a known intermittent environmental issue, a product regression, or other causes.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to filtering out failure events with known causes from a test report. A test case run analyzer may receive a test report of a test case run of an application process. The test case run analyzer may automatically identify a failure event in the test case run. The test case run analyzer may automatically compare the failure event to a failure pattern set. The test case run analyzer may filter the test report based on the failure pattern set.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing device.

FIG. 2 illustrates, in a block diagram, one embodiment of a failure event analysis.

FIG. 3 illustrates, in a block diagram, one embodiment of a failure analysis system.

FIG. 4 illustrates, in a block diagram, one embodiment of a failure pattern record.

FIG. 5 illustrates, in a flowchart, one embodiment of a method to analyze a set of test case run data.

FIG. 6 illustrates, in a flowchart, one embodiment of a method to filter a test report.

FIG. 7 illustrates, in a flowchart, one embodiment of a method to analyze a failure event.

FIG. 8 illustrates, in a flowchart, one embodiment of a method to connect a failure event with multiple patterns.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable storage medium having a set of instructions detailing a method stored thereon for at least one processor, or a test case run analyzer.

A testing module may execute a test case run of an application process to determine whether the application process is functioning properly. The testing module may then compile a test report describing the performance of the application process, including indicating any failure events that occur. A test case run analyzer may use a set of failure patterns representing known failure events to filter out those known failure events from the test report. The test case run analyzer may use advanced analysis to perform test case level failure investigation. The test case run analyzer may create a set of rules, or a failure pattern, that describes a specific failure and the corresponding failure cause. The test case run analyzer may then apply any fixes, or curative actions, for these failure causes to any matching failures events.

The test case run analyzer may use automatic analysis to automatically apply the failure patterns created through advanced analysis to future test pass failures, automatically associating the failure causes with the failure events. The failure patterns may be created manually, and then applied automatically to future results. Machine learning may allow the automatic creation of a failure pattern.

The test case run analyzer may gather evidence from a failed result log, or test report, specifying the specific logged failure content as well as the context surrounding the failure. The test case run analyzer may transform the test reports into a standard format before being displayed in the user interface to facilitate creating a failure pattern. The test reports may be formatted in extensible markup language (XML). The evidence may include information such as the test case being run, the hardware the test was run on, or specific information from the test pass that is found in the test log.

A failure pattern record may match a failure pattern to a failure cause. The failure pattern may be described using XML, such as an XML Path®, or X-Path®, language. A failure pattern may be matched to evidence in the test report. Once a failure pattern has been authored, that failure pattern may be automatically applied to the corresponding failure events to any matching failures. A failure event may be associated with multiple failure patterns. Conversely, a failure pattern may be associated with multiple failure events.

Thus, in one embodiment, a test case run analyzer may filter out failure events with known causes from a test report. A test case run analyzer may receive a test report of a test case run of an application process. The test case run analyzer may automatically identify a failure event in the test case run. The test case run analyzer may automatically compare the failure event to a failure pattern set. The test case run analyzer may filter the test report based on the failure pattern set. The test case run analyzer may associate one or more failure patterns in the failure pattern set to one or more bug reports.

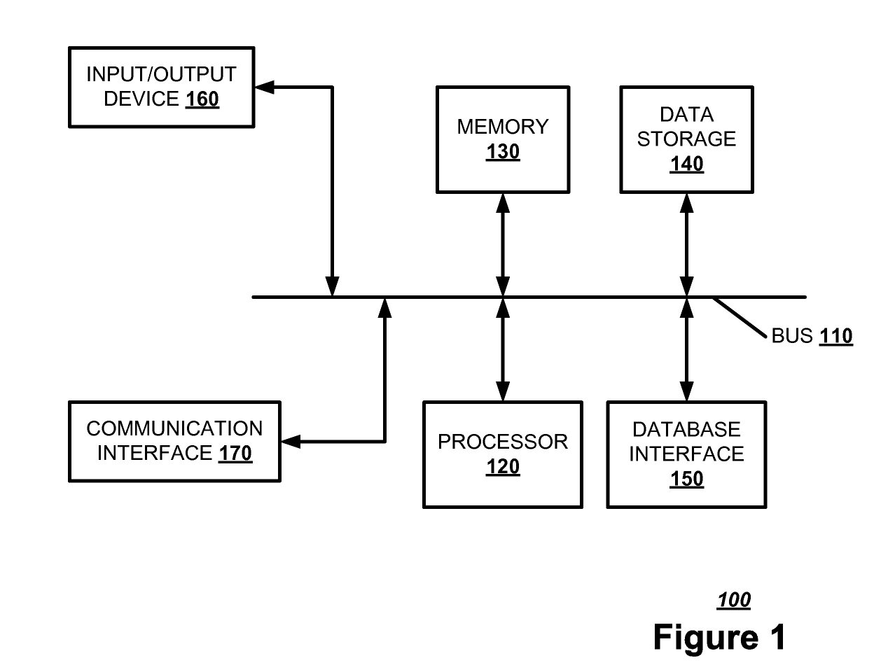

FIG. 1 illustrates a block diagram of an exemplary computing device 100 which may act as a test case run analyzer. The computing device 100 may combine one or more of hardware, software, firmware, and system-on-a-chip technology to implement a test case run analyzer. The computing device 100 may include a bus 110, a processor 120, a memory 130, a data storage 140, a database interface 150, an input/output device 160, and a communication interface 170. The bus 110, or other component interconnection, may permit communication among the components of the computing device 100.

The processor 120 may include at least one conventional processor or microprocessor that interprets and executes a set of instructions. The memory 130 may be a random access memory (RAM) or another type of dynamic data storage that stores information and instructions for execution by the processor 120. The memory 130 may also store temporary variables or other intermediate information used during execution of instructions by the processor 120. The data storage 140 may include a conventional ROM device or another type of static data storage that stores static information and instructions for the processor 120. The data storage 140 may include any type of tangible machine-readable storage medium, such as, for example, magnetic or optical recording media, such as a digital video disk, and its corresponding drive. A tangible machine-readable storage medium is a physical medium storing machine-readable code or instructions, as opposed to a signal that propagates machine-readable code or instructions. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable storage media/medium having instructions stored thereon, in this or an analogous form, references tangible media on which data may be stored or retained. The data storage 140 may store a set of instructions detailing a method that when executed by one or more processors cause the one or more processors to perform the method. A database interface 150 may connect to a database for storing test reports or a database for storing failure patterns.

The input/output device 160 may include one or more conventional mechanisms that permit a user to input information to the computing device 100, such as a keyboard, a mouse, a voice recognition device, a microphone, a headset, a gesture recognition device, a touch screen, etc. The input/output device 160 may include one or more conventional mechanisms that output information to the user, including a display, a printer, one or more speakers, a headset, or a medium, such as a memory, or a magnetic or optical disk and a corresponding disk drive. The communication interface 170 may include any transceiver-like mechanism that enables computing device 100 to communicate with other devices or networks. The communication interface 170 may include a network interface or a transceiver interface. The communication interface 170 may be a wireless, wired, or optical interface.

The computing device 100 may perform such functions in response to processor 120 executing sequences of instructions contained in a computer-readable medium, such as, for example, the memory 130, a magnetic disk, or an optical disk. Such instructions may be read into the memory 130 from another computer-readable medium, such as the data storage 140, or from a separate device via the communication interface 170.

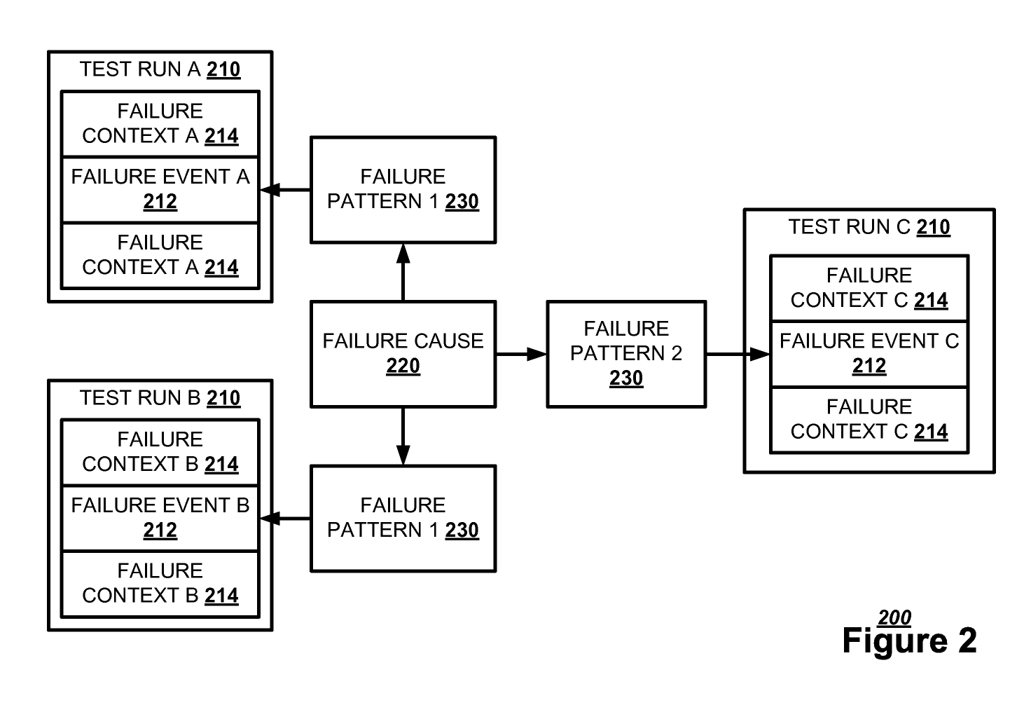

FIG. 2 illustrates, in a block diagram, one embodiment of a failure event analysis 200. A tester may analyze an application process by executing a test case run 210 of the application process. A test case run 210 is the execution of the application process under controlled circumstances. During execution of the test case run, the application process may produce a failure event 212. A failure event 212 is an instance in which the test case run 210 performs improperly, such as terminating, producing an incorrect result, entering a non-terminating loop, or producing some other execution error. The failure context 214 describes the circumstances in which the failure event 212 occurred. A failure context 214 may describe the hardware performing the application process, the data being input into the application process, environmental factors, and other data external to the execution of the application process.

The failure event 212 may be produced by a failure cause 220. A failure cause 220 describes a bug or other issue that is producing the failure event 212. A failure pattern 230 describes the failure event 212 as produced by the test case run 210. A failure pattern 230 may describe the type of failure, the type of function or call in which the failure event 212 occurs, the placement of the failure event 212 in the application process, and other data internal to the execution of the application process. A failure pattern 230 may describe a failure event 212 in multiple different test case runs executed under multiple different circumstances. Additionally, a failure cause 220 may produce multiple different failure patterns 230.

For example, a failure cause 220 may produce Failure Pattern 1 230 and Failure Pattern 2 230. Failure Pattern 1 230 may describe Failure Event A 212 in Test Case Run A 210 and Failure Event B 212 in Test Case Run B 210, while Failure Pattern 2 230 may describe Failure Event C 212 in Test Case Run C 210. Thus, Failure Event A 212, Failure Event B 212, and Failure Event C 212 may all result from the same failure cause 220.

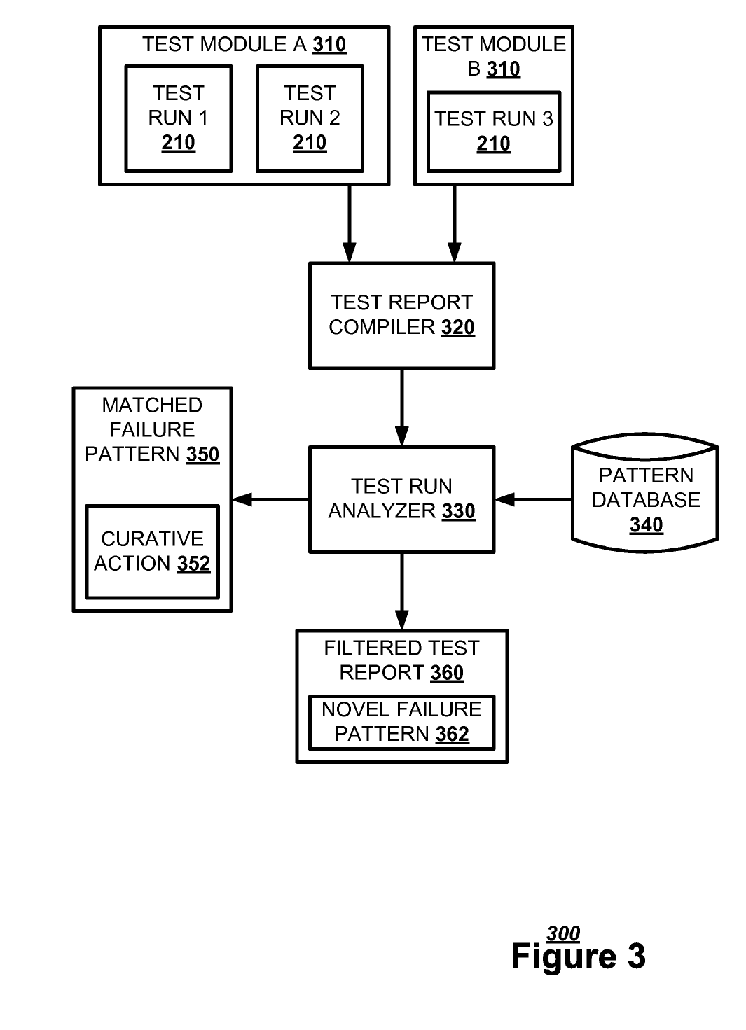

FIG. 3 illustrates, in a block diagram, one embodiment of a failure analysis system 300. While multiple modules are shown, each of these modules may be consolidated with the other modules. Each module may be executed on the same computing device 100 or the modules may be distributed across multiple computing devices, either networked or not. Additionally, each individual module may run across multiple computing devices in parallel. A test module 310 may execute one or more test case runs 210 of one or more application processes. A test report compiler 320 may compile the results of one or more of the test case runs 210 into a test report. The test report compiler 320 may convert the test report into a hierarchical data format. A test case run analyzer 330 may analyze the test report to identify a failure event 212, as well as a failure context 214 surrounding the failure event 212. Additional failure context 214 may be input in to the test case run analyzer 330.

The test case run analyzer 330 may automatically compare any identified failure events 212 to a failure pattern set stored in a failure pattern database 340. If a failure event 212 matches a matched failure pattern 350 in the failure pattern database 340, the test case run analyzer 330 may initiate a curative action 352 associated with that matched failure pattern 350, if available. The failure event 212 with a matched failure pattern 350 may be filtered from the final filtered test report 360, using failure events 212 in the final filtered test report 360 to create a novel failure pattern 362. The final filtered test report 360 may have multiple filtered subordinate test-run reports. The final filtered test report 360 may have a summary of analysis noting which failure causes have or have not been recognized.

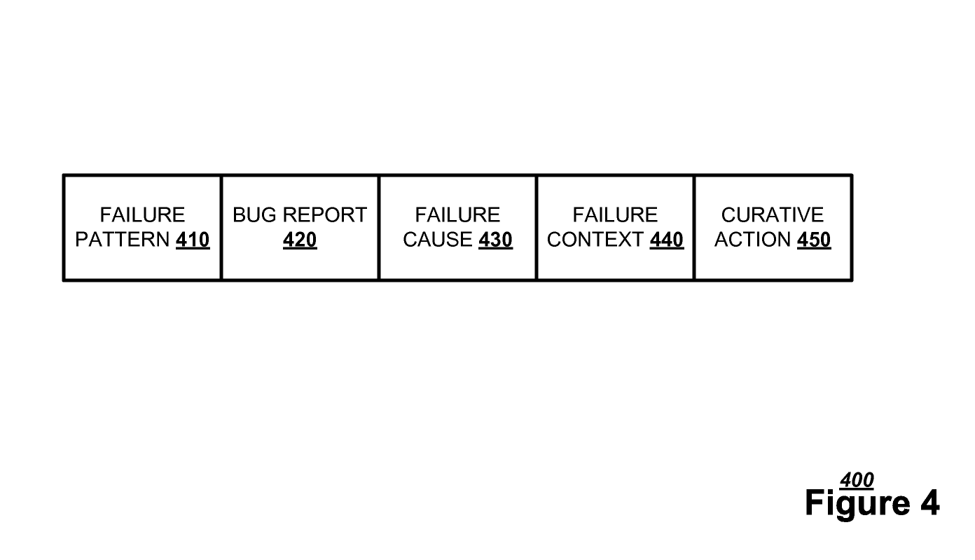

The failure pattern database 340 may store several failure pattern records describing several failure patterns 230. FIG. 4 illustrates, in a block diagram, one embodiment of a failure pattern record 400. The failure pattern record 400 may have a failure pattern field 410 that describe the failure pattern 230. The failure pattern record 400 may associate with one or more bug reports 420, describing a failure event that may result in the failure pattern 230. The bug report 420 may have one or more failure cause fields 430, each describing a failure cause 220 that may result in the failure pattern 230 described in the failure pattern field 410. Each failure cause field 430 may have a failure context field 440 describing a failure context 214 to differentiate between failure causes 220 with a similar failure pattern 230. The failure pattern record 400 may have a curative action field 450 to associate any known curative actions 352 with the failure cause 220.

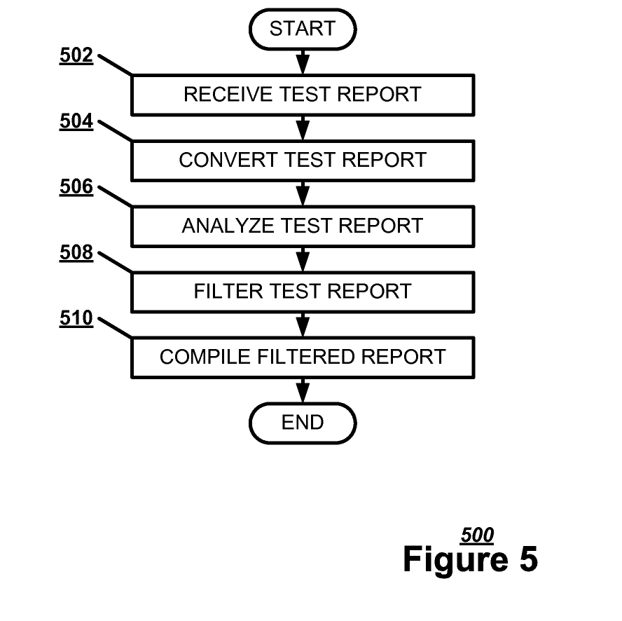

FIG. 5 illustrates, in a flowchart, one embodiment of a method 500 to analyze a set of test case run data. The test case run analyzer 330 may receive a test report of a test case run 210 of an application process (Block 502). The test case run analyzer 330 may convert the test report to a hierarchical format (Block 504). The test case run analyzer 330 may analyze the test report (Block 506). The test case run analyzer 330 may filter the test report of the test case run 210 based on the failure pattern set (Block 508). The test case run analyzer 330 may compile a filtered test report 360 removing any failure event 212 with a matching failure pattern 350 (Block 510). The filtered test report 360 may be forwarded to an administrator for further analysis.

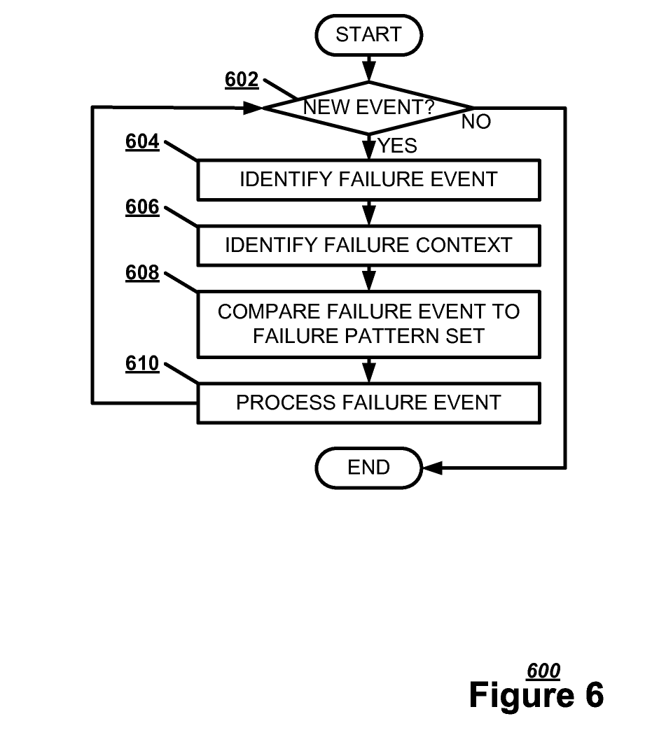

FIG. 6 illustrates, in a flowchart, one embodiment of a method 600 to analyze a set of test case run data. If the test case run analyzer 330 detects a failure event in the test report (Block 602), the test case run analyzer 330 may automatically identify a failure event 212 in the test case run 210 (Block 604). The test case run analyzer 330 may automatically identify a failure context 214 surrounding the failure event 212 (Block 606). The test case run analyzer 330 may automatically compare the failure event 212 to a failure pattern set (Block 608). The test case run analyzer 330 may process the failure event 212 based on the comparison (Block 610).

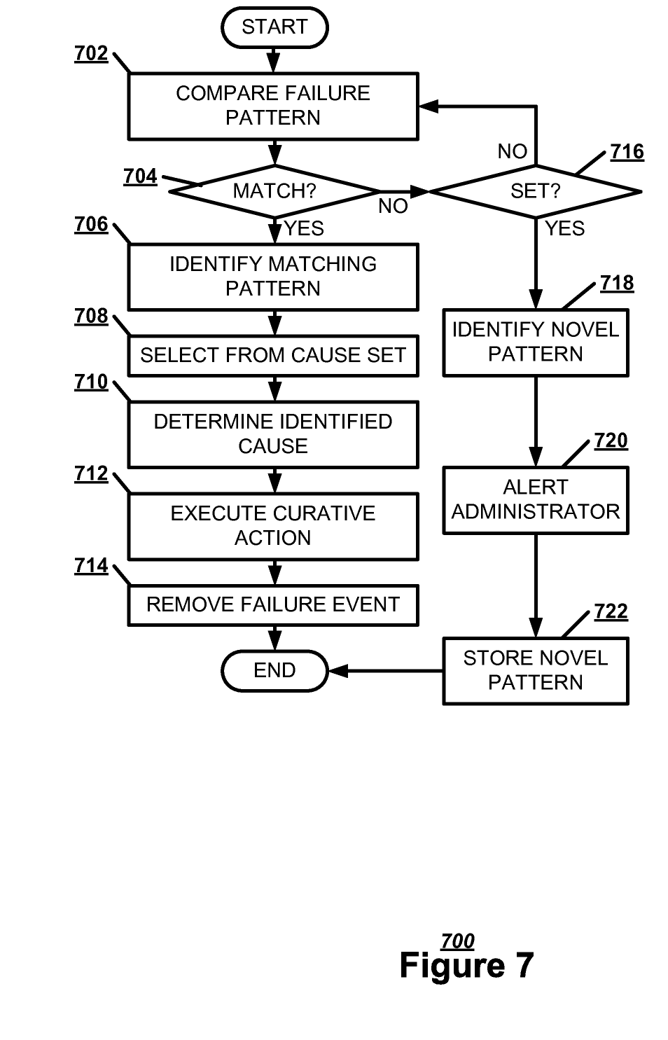

FIG. 7 illustrates, in a flowchart, one embodiment of a method 700 to analyze a failure event. The test case run analyzer 330 may automatically compare the failure event 212 to a failure pattern 230 of the failure pattern set (Block 702). If the failure event 212 matches the failure pattern 230 (Block 704), the test case run analyzer 330 may automatically identify a matching failure pattern 230 with the failure event 212 (Block 706). The test case run analyzer 330 may select from an identified failure cause set associated with the failure event using a failure context (Block 708). The test case run analyzer 330 may determine an identified failure cause 220 from the matching failure pattern 350 (Block 710). The test case run analyzer 330 may execute a curative action 352 associated with the identified failure cause 220 (Block 712). The test case run analyzer 330 may remove the failure event 212 from the test report when associated with a matching failure pattern 350 (Block 714).

If the failure event 212 does not match the failure pattern 230 (Block 704), and each failure pattern 230 in the failure pattern set has been compared to the failure event 212 (Block 716), then the test case run analyzer 330 may identify a novel failure pattern 362 based on the failure event 212 (Block 718). The test case run analyzer 330 may alert an administrator to the novel failure pattern 362 (Block 720). The test case run analyzer 330 may alert the administrator by sending the filtered test report 360 in an e-mail to the administrator or by texting a link to the filtered test report 360. The test case run analyzer 330 may store a novel failure pattern 362 in the failure pattern database 340 for later use (Block 722). The test case run analyzer 330 may use machine learning to analyze and reduce individual or multiple novel failures into a useful generalized novel failure pattern 362. Alternately, an administrator may create the novel failure pattern 362 using a user interface.

A predecessor failure pattern 230 may be connected to a successor failure pattern 230 in a failure pattern record 400 to indicate that the predecessor failure pattern 230 and the successor failure pattern 230 may result from similar or the same failure cause 220. Thus, a predecessor failure event 212 and a successor failure event 212 may be connected in a filtered test report 360 to indicate a similar or the same failure cause 220.

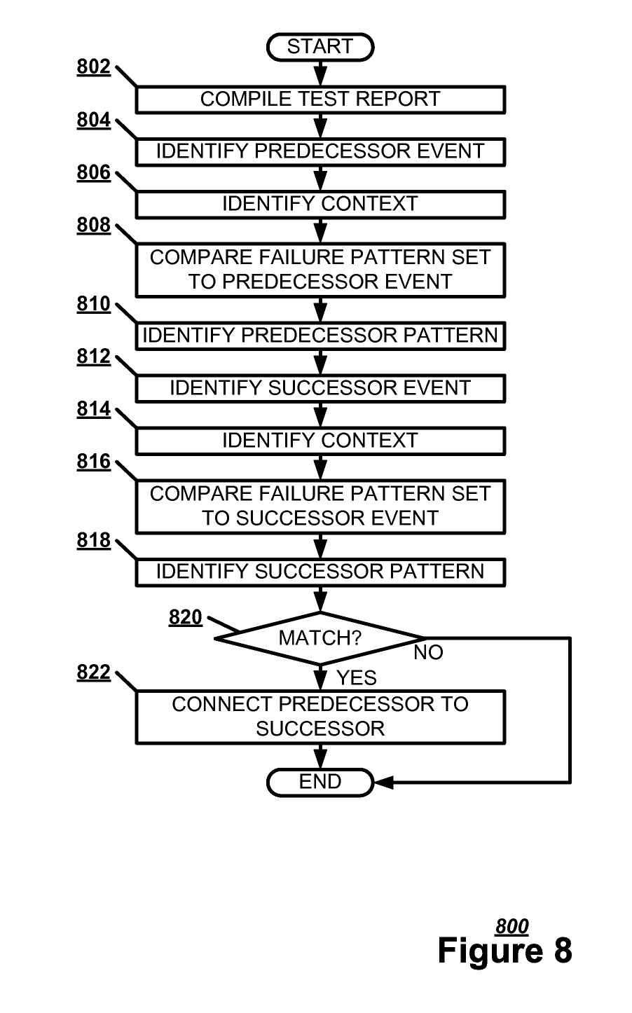

FIG. 8 illustrates, in a flowchart, one embodiment of a method 800 to connect a failure event with multiple patterns. The test case run analyzer 330 may compile a test report of a test case run 210 of an application process (Block 802). The test case run analyzer 330 may automatically identify a predecessor failure event 212 in the test case run 210 of an application process (Block 804). The test case run analyzer 330 may automatically identify a failure context 214 surrounding the predecessor failure event 212 (Block 806). The test case run analyzer 330 may automatically compare the predecessor failure event 212 to a failure pattern set (Block 808), as described in FIG. 7. The test case run analyzer 330 may automatically identify the predecessor matching failure pattern with the predecessor failure event of the test report (Block 810).

The test case run analyzer 330 may automatically identify a successor failure event 212 in the test case run 210 (Block 812). The test case run analyzer 330 may automatically identify a failure context 214 surrounding the successor failure event 212 (Block 814). The test case run analyzer 330 may automatically compare the successor failure event 212 to a failure pattern set (Block 816), as described in FIG. 7. The test case run analyzer 330 may automatically identify the successor matching failure pattern with the successor failure event of the test report (Block 818). If the successor matching failure pattern 230 is connected to the predecessor matching failure pattern 230 (Block 820), the test case run analyzer 330 may connect the successor failure event 212 to the predecessor failure event 212 (Block 822).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
receiving a test report of a test case run of an application process;
identifying automatically a failure event in the test case run;
comparing automatically the failure event to a failure pattern set; and
filtering the test report based on the failure pattern set.

2. The method of claim 1, further comprising:
identifying automatically a failure context surrounding the failure event.

3. The method of claim 1, further comprising:
converting the test report to a hierarchical format.

4. The method of claim 1, further comprising:
identifying a novel failure pattern based on the failure event.

5. The method of claim 1, further comprising:
alerting an administrator to a novel failure pattern.

6. The method of claim 1, further comprising:
identifying a matching failure pattern with the failure event.

7. The method of claim 1, further comprising:
determining an identified failure cause from a matching failure pattern.

8. The method of claim 1, further comprising:
selecting from an identified failure cause set associated with the failure event using a failure context.

9. The method of claim 1, further comprising:
executing a curative action associated with an identified failure cause.

10. The method of claim 1, further comprising:
removing the failure event from the test report when associated with a matching failure pattern.

11. The method of claim 1, further comprising:
compiling a filtered test report removing the failure event with a matching failure pattern.

12. A tangible machine-readable medium having a set of instructions detailing a method stored thereon that when executed by one or more processors cause the one or more processors to perform the method, the method comprising:
identifying automatically a predecessor failure event in a test case run of an application process;
comparing automatically the predecessor failure event to a failure pattern set; and
filtering a test report of the test case run based on the failure pattern set.

13. The tangible machine-readable medium of claim 12, wherein the method further comprises:
identifying automatically a failure context surrounding the predecessor failure event.

14. The tangible machine-readable medium of claim 12, wherein the method further comprises:
identifying automatically a successor matching failure pattern with a successor failure event of the test report.

15. The tangible machine-readable medium of claim 14, wherein the method further comprises:
connecting the successor failure event to the predecessor failure event if the successor matching failure pattern is connected to a predecessor matching failure pattern.

16. The tangible machine-readable medium of claim 12, wherein the method further comprises:
identifying automatically a predecessor matching failure pattern with the predecessor failure event.

17. The tangible machine-readable medium of claim 12, wherein the method further comprises:
determining an identified failure cause from a predecessor matching failure pattern.

18. The tangible machine-readable medium of claim 12, wherein the method further comprises:
executing a curative action associated with an identified failure cause.

19. A test case run analyzer, comprising:
an input/output device that receives a test report of a test case run of an application process having a failure event and a failure context;
a database interface that connects to a database storing a failure pattern set; and
a processor that automatically identifies the failure event and the failure context, automatically compares the failure event to the failure pattern set, and filters the test report based on the failure pattern set.

20. The test case run analyzer of claim 19, wherein the processor removes the failure event from the test report when associated with a matching failure pattern.
